(19) United States
(12) Patent Application Publication
(10) Pub. No.: US 2014/0242312 A1
(43) Pub. Date: Aug. 28, 2014

(54) SILICONE RUBBER-BASED CURABLE COMPOSITION, METHOD OF PRODUCING SILICONE RUBBER, SILICONE RUBBER, MOLDED BODY AND MEDICAL TUBE

(71) Applicant: SUMITOMO BAKELITE COMPANY LIMITED, Shinagawa-ku (JP)

(72) Inventors: Taketoshi Murai, Shinagawa-ku (JP); Kazunobu Senoo, Shinagawa-ku (JP); Jun Okada, Shinagawa-ku (JP); Motoyoshi Tsujimoto, Shinagawa-ku (JP)

(73) Assignee: SUMITOMO BAKELITE COMPANY LIMITED, Shinagawa-ku (JP)

(21) Appl. No.: 14/346,116

(22) PCT Filed: Sep. 20, 2012
(86) PCT No.: PCT/JP2012/074001

§ 371 Date: Mar. 20, 2014

(30) Foreign Application Priority Data
Sep. 20, 2011 (JP) 2011-205134

(51) Int. Cl. C08L 43/04

(52) U.S. Cl. CPC C08L 43/04
USPC 428/35.8; 524/547; 428/36.4

(57) ABSTRACT

A silicone rubber-based curable composition of the present invention contains: a vinyl group-containing organopolysiloxane (A); an organohydrogen polysiloxane (B); silica particles (C); a silane coupling agent (D); and a platinum or platinum compound (E), wherein satisfied is the following requirement X, or both the following requirements X and Y: Requirement X: the vinyl group-containing organopolysiloxane (A) contains both a vinyl group-containing linear organopolysiloxane (A1) and a vinyl group-containing branch organopolysiloxane (A2), Requirement Y: the organohydrogen polysiloxane (B) contains a mixture (B3) of a linear organohydrogen polysiloxane (B1) and a branch organohydrogen polysiloxane (B2), or the branch organohydrogen polysiloxane (B2). This makes it possible to provide a silicon rubber-based curable composition which can produce a silicone rubber having excellent tensile strength and tearing strength.

### TECHNICAL FIELD

The present invention relates to a silicone rubber-based curable composition, a method of producing a silicone rubber, a silicone rubber, a molded body and a medical tube.

### RELATED ART

Since a silicone rubber has excellent heat resistance, flame resistance, chemical reliability, weather resistance, radiation resistance, electrical properties and the like, it is used for various applications in a wide field.

For example, a silicon-based resin having high transparency is used as an optical material such as a material for encapsulating a LED, and a silicon-based resin having high strength and superior transparency is used as a material of an optical wave guiding board included in a backlight device for irradiating a keypad.

Especially, since a silicone rubber is physiologically inactive and has poor reactivity against body tissues when making contact with a living body, it is also used as materials of medical devices such as various kinds of medical catheters and medical sealing materials.

For example, a medical catheter (medical tube) is a pipe to be used by being inserted into abdominal cavities such as a thoracic cavity and an abdominal cavity, lumens such as a digestive tract and a urinary duct, veins and the like, and then draining a body fluid or injecting a liquid medicine, a nutritional supplement and a contrast medium and the like. Therefore, the medical catheter is required to have scratch resistance (anti-tearing property), an anti-kink property (tensile strength), transparency, flexibility (tensile elongation property) and the like in addition to biocompatibility. Concrete examples of such a medical catheter include a drainage tube of a suction apparatus for removing waste fluids such as blood and pus after surgery, a tube for receiving nutrition after surgery such as percutaneous endoscopic gastrostomy (PEG), and the like.

Further, in the case where the silicone rubber is formed into a tubular shape in order to use as the catheter, a silicone rubber composition for producing the silicone rubber is required to exhibit good moldability during extrusion molding thereof. Furthermore, in the case where the silicone rubber is formed into a fine tubular shape, the silicone rubber composition has to have higher tensile strength so as not to cut.

In this regard, the silicone rubber is required to have high transparency in order to visually observe a fluid and an amount thereof inside products including the catheter. Further, the silicone rubber is often required to have such higher transparency that makes it possible to keep visibility of inside of a product having a large thickness.

Here, as the material of the medical catheter, flexible polyvinyl chloride and the like are generally used along with the silicone rubber. The silicone rubber has more excellent biocompatibility and flexibility as compared with the polyvinyl chloride and the like, but is required to improve strengths such as tearing strength and tensile strength, especially, the tearing strength. If the silicone rubber does not have sufficient tearing strength, the catheter is broken by being damaged with a needle, a knife and the like during surgery. Further, if the silicone rubber does not have sufficient tensile strength, the catheter is bent so as to block (kink) a lumen thereof so that a body fluid to be drained, a liquid medicine to be injected or the like is retained inside thereof.

Therefore, in order to improve the tearing strength and the tensile strength of the silicone rubber, various methods are proposed (For example, Patent documents 1 to 7). Concrete examples of a method of imparting high tearing strength to the silicone rubber include a method of adding an inorganic filler such as silica particles to the silicone rubber, a method of making different crosslink densities in the silicone rubber (distributing areas having high crosslink densities and areas having low crosslink densities in a silicone rubber system), and the like. It is conceived that the improvement of the tearing strength by making the different crosslink densities results from an action of the areas having high crosslink density as resistance force against the tearing strength.

More specifically, Patent document 1 discloses a curable silicone rubber composition containing an organopolysiloxane having a high viscosity and a vinyl group in a small amount (raw rubber (A)) as a main component thereof, and an organopolysiloxane having a low viscosity and a vinyl group in a large amount (silicone oil (B)), a vinyl group-containing organopolysiloxane copolymer (vinyl group-containing silicone resin (C)) an organohydrogen siloxane (crosslinking agent (D)), a platinum or platinum compound (curing catalyst (E)) and fine powder silica (filler (F)).

However, even if the organopolysiloxane having the vinyl group in the large amount is used by being mixed with the organopolysiloxane having the vinyl group in the different amount, there is a problem in that the tensile strength of the silicone rubber can be improved due to increase of crosslinking points, but sufficient tearing strength cannot be imparted to the silicone rubber.

### PRIOR ART DOCUMENT

### Patent Document

Patent document 1: JP-A H07-331079

Patent document 2: JP-A H07-228782

Patent document 3: JP-A H07-258551

Patent document 4: U.S. Pat. No. 3,884,866

Patent document 5: U.S. Pat. No. 4,539,357

Patent document 6: U.S. Pat. No. 4,061,609

Patent document 7: U.S. Pat. No. 3,671,480

### SUMMARY OF THE INVENTION

### Problem to be Solved by the Invention

An object of the present invention is to provide a silicon rubber-based curable composition which can produce a silicone rubber having excellent tensile strength and tearing strength, a method of producing a silicone rubber by using the silicon rubber-based curable composition, a silicone rubber produced by using the silicon rubber-based curable composition, a molded body obtained by using the silicon rubber-based curable composition, and a medical tube obtained by bringing the molded body into a tubular shape.

### Means for Solving Problem

In order to achieve such an object, the present invention includes the following features (1) to (16).

(1) A silicone rubber-based curable composition, comprising:

a vinyl group-containing organopolysiloxane (A);

an organohydrogen polysiloxane (B);

silica particles (C);

a silane coupling agent (D); and

a platinum or platinum compound (E),

wherein satisfied is the following requirement X, or both the following requirements X and Y:

Requirement X: the vinyl group-containing organopolysiloxane (A) contains both a vinyl group-containing linear organopolysiloxane (A1) and a vinyl group-containing branch organopolysiloxane (A2),

Requirement Y: the organohydrogen polysiloxane (B) contains a mixture (B3) of a linear organohydrogen polysiloxane (B1) and a branch organohydrogen polysiloxane (B2), or the branch organohydrogen polysiloxane (B2).

(2) The silicone rubber-based curable composition according to the above feature (1), wherein the vinyl group-containing linear organopolysiloxane (A1) is represented by the following formula (1):

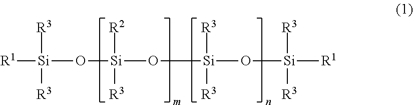

where in the formula (1), “m” is an integer number of 1 to 1,000, “n” is an integer number of 3,000 to 10,000, R¹ is a substituted or unsubstituted alkyl, alkenyl or aryl group having a carbon number of 1 to 10 or a hydrocarbon group combining them, R² is a substituted or unsubstituted alkyl, alkenyl or aryl group having a carbon number of 1 to 10 or a hydrocarbon group combining them, and R³ is a substituted or unsubstituted alkyl or aryl group having a carbon number of 1 to 8 or a hydrocarbon group combining them, but at least one of R¹ and R² is the hydrocarbon group containing the substituted or unsubstituted alkenyl group having the carbon number of 1 to 10.

(3) The silicone rubber-based curable composition according to the above feature (1), wherein the vinyl group-containing branch organopolysiloxane (A2) is represented by the following formula (4):

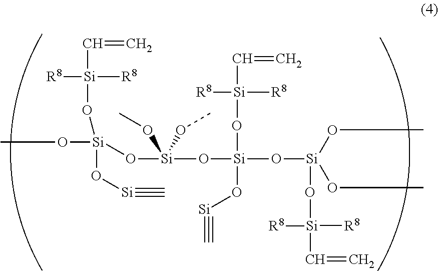

where in the formula (4), R⁸ is a substituted or unsubstituted alkyl or aryl group having a carbon number of 1 to 8 or a hydrocarbon group combining them, “—O—Si≡” represents that Si has a branch structure spreading in three dimension.

(4) The silicone rubber-based curable composition according to the above feature (1), wherein the linear organohydrogen polysiloxane (B1) is represented by the following formula (2):

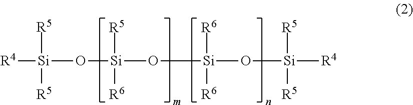

where in the formula (2), “m” is an integer number of 0 to 300, “n” is an integer number of “300-m”, R⁴ is a substituted or unsubstituted alkyl, alkenyl or aryl group having a carbon number of 1 to 10, a hydrocarbon group combining them or a hydrido group, R⁵ is a substituted or unsubstituted alkyl, alkenyl or aryl group having a carbon number of 1 to 10, a hydrocarbon group combining them or a hydrido group, and R⁶ is a substituted or unsubstituted alkyl or aryl group having a carbon number of 1 to 8 or a hydrocarbon group combining them, but at least two of R⁴s and R⁵s are the hydrido groups.

(5) The silicone rubber-based curable composition according to the above feature (1), wherein the branch organohydrogen polysiloxane (B2) is represented by the following average composition formula (C):

(Hₐ(R⁷)₃₋ₐSiO_{1/2})ₘ(SiO_{4/2})ₙ (C)

where in the formula (C), R⁷ is an univalent organic group, “a” is an integer number of 1 to 3, “m” is the number of “Hₐ(R⁷)₃₋ₐSiO_{1/2}” unit, and “n” is the number of “SiO_{4/2}” unit.

(6) The silicone rubber-based curable composition according to the above feature (1), wherein the mixture (B3) contains the linear organohydrogen polysiloxane (B1) and the branch organohydrogen polysiloxane (B2) in a weight ratio of 10:1 to 1:1.

(7) The silicone rubber-based curable composition according to the feature (1), wherein the silane coupling agent (D) has a hydrolysable group that reacts with a hydroxyl group of the silica particles (C) through dehydration and condensation reaction after being hydrolyzed.

(8) The silicone rubber-based curable composition according to the above feature (7), wherein the silane coupling agent (D) has a hydrophobic group.

(9) The silicone rubber-based curable composition according to the above feature (7), wherein the silane coupling agent (D) has a vinyl group.

(10) The silicone rubber-based curable composition according to the above feature (1), further comprising a water (F).

(11) A method of producing a silicone rubber by curing the silicone rubber-based curable composition according to the above feature (1) and satisfying both the following requirements X and Y, comprising:

obtaining a kneaded product by kneading at least the vinyl group-containing linear organopolysiloxane (A1), the silica particles (C) and the silane coupling agent (D) with each other; and

obtaining the silicone rubber-based curable composition by kneading at least the mixture (B3) or branch organohydrogen polysiloxane (B2) and the platinum or platinum compound (E) with the kneaded product,

wherein the vinyl group-containing branch organopolysiloxane (A2) is kneaded with the vinyl group-containing linear organopolysiloxane (A1), the silica particles (C) and the silane coupling agent (D) in the kneaded product obtaining step, or is kneaded with the kneaded product together with the mixture (B3) or branch organohydrogen polysiloxane (B2) and the platinum or platinum compound (E) in the silicone rubber-based curable composition obtaining step.

(12) The method of producing a silicone rubber according to the above feature (11), wherein the kneaded product is obtained by kneading, in advance, the vinyl group-containing linear organopolysiloxane (A1) and the silane coupling agent (D) with each other, and then kneading the silica particles (C) therewith.

(13) The method of producing a silicone rubber according to the above feature (12), wherein the silicone rubber-based curable composition is obtained by kneading the vinyl group-containing branch organopolysiloxane (A2) and the mixture (B3) or branch organohydrogen polysiloxane (B2) with a part of the kneaded product, and kneading the platinum or platinum compound (E) with the other part of the kneaded product, and then kneading the kneaded products with each other.

(14) A silicone rubber produced by curing the silicone rubber-based curable composition according to the above feature (1).

(15) A molded body obtained by using the silicone rubber according to the above feature (14).

(16) A medical tube obtained by bringing the molded body according to the above feature (15) into a tubular shape.

### Effect of the Invention

A silicone rubber produced by curing a silicon rubber-based curing composition of the present invention, that is, a silicone rubber produced by using a method of producing a silicone rubber of the present invention can exhibit excellent tensile strength and tearing strength. Therefore, a molded body molded by using the produced silicone rubber, and a medical tube formed from this molded body can exhibit mechanical strengths such as tensile strength and tearing strength.

Especially, by using a vinyl group-containing branch organopolysiloxane (branch high vinyl component) as a vinyl group-containing organopolysiloxane, it is possible to obtain a silicone rubber having improved tensile strength, while suppressing hardness and modulus of the silicone rubber from extremely becoming high, that is, without changing usability and hardness thereof.

Further, by using a branch organohydrogen polysiloxane as an organohydrogen polysiloxane, the produced silicone rubber can exhibit excellent mechanical strengths.

Further, by using a silane coupling agent having a hydrophobic group as a silane coupling agent, it is possible for the silicone rubber to have improved mechanical strength and to make transparency thereof high.

In the case where the silicone rubber is used as a material of the medical catheter, the silicone rubber is required to have a certain degree of hardness. For example, if a catheter is formed of a material having low hardness, it is easy to cause problems such as deformation (so-called bend) due to insertion resistance when inserting the catheter into a purpose part (e.g., thoracic cavity) and occlusion of a lumen thereof due to a low anti-kink property. On the other hand, by making the hardness and modulus of the silicone rubber high, the above problems can be resolved for a catheter formed of such a silicone rubber.

Especially, by using a silane coupling agent having a vinyl group as the silane coupling agent, it is possible to further improve the hardness and modulus of the produced silicone rubber.

### MODE FOR CARRYING OUT THE INVENTION

Hereinafter, description will be made on a silicone rubber-based curable composition, a method of producing a silicone rubber, a silicone rubber, a molded body and a medical tube in detail based on preferred embodiments.

<Silicon Rubber-Based Curable Composition>

First, description will be made on a silicon rubber-based curable composition of the present invention.

The silicon rubber-based curable composition of the present invention contains a vinyl group-containing organopolysiloxane (A), an organohydrogen polysiloxane (B), silica particles (C), a silane coupling agent (D) and a platinum or platinum compound (E), and is characterized by satisfying the following requirement X or both the following requirements X and Y.

Requirement X: The vinyl group-containing organopolysiloxane (A) contains both a vinyl group-containing linear organopolysiloxane (A1) and a vinyl group-containing branch organopolysiloxane (A2).

Requirement Y: The organohydrogen polysiloxane (B) contains a mixture (B3) of a linear organohydrogen polysiloxane (B1) and a branch organohydrogen polysiloxane (B2) or the branch organohydrogen polysiloxane (B2).

Hereinafter, description will be made on each component constituting the silicon rubber-based curable composition of the present invention in order.

<<Vinyl Group-Containing Organopolysiloxane (A)>>

The vinyl group-containing organopolysiloxane (A) is a polymer contained in the silicon rubber-based curable composition of the present invention as a major component thereof.

This vinyl group-containing organopolysiloxane (A) is classified into a vinyl group-containing linear organopolysiloxane (A1) and a vinyl group-containing branch organopolysiloxane (A2). In the present invention, used are both the vinyl group-containing linear organopolysiloxane (A1) and the vinyl group-containing branch organopolysiloxane (A2).

<Vinyl Group-Containing Linear Organopolysiloxane (A1)>

The vinyl group-containing linear organopolysiloxane (A1) has a linear chain structure and contains a vinyl group which forms a crosslinking point when the silicon rubber-based curable composition is cured.

An amount of the vinyl group contained in the vinyl group-containing linear organopolysiloxane (A1) is not limited to a specific value, but preferably in the range of 0.01 to 15 mol %, and more preferably in the range of 0.05 to 12 mol %. This makes it possible to optimize the amount of the vinyl group contained in the vinyl group-containing linear organopolysiloxane (A1), to thereby reliably form a network with the respective components described below.

In this specification, the amount of the vinyl group means that mol % of a vinyl group-containing siloxane unit when defining all units constituting the vinyl group-containing linear organopolysiloxane (A1) as 100 mol %. In this regard, one vinyl group-containing siloxane unit is assumed to have one vinyl group.

Further, a polymerization degree of the vinyl group-containing linear organopolysiloxane (A1) is not limited to a specific value, but preferably in the range of about 3,000 to 10,000, and more preferably in the range of about 4,000 to 8,000.

Furthermore, a specific gravity of the vinyl group-containing linear organopolysiloxane (A1) is not limited to a specific value, but preferably in the range of about 0.9 to 1.1.

By using an organopolysiloxane having a polymerization degree and specific gravity falling within the above ranges as the vinyl group-containing linear organopolysiloxane (A1), it is possible to improve heat resistance, flame resistance, chemical reliability and the like of the produced silicone rubber.

As the vinyl group-containing linear organopolysiloxane (A1), an organopolysiloxane having a structure represented by the following formula (1) is especially preferable.

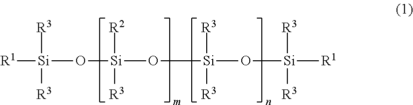

in the formula (1), R¹ is a substituted or unsubstituted alkyl, alkenyl or aryl group having a carbon number of 1 to 10 or a hydrocarbon group combining them. Examples of the alky group having the carbon number of 1 to 10 include a methyl group, an ethyl group, a propyl group and the like. Among them, the methyl group is preferable. Examples of the alkenyl group having the carbon number of 1 to 10 include a vinyl group, an allyl group, a butenyl group and the like. Among them, the vinyl group is preferable. Examples of the aryl group having the carbon number of 1 to 10 include a phenyl group and the like.

Further, R² is a substituted or unsubstituted alkyl, alkenyl or aryl group having a carbon number of 1 to 10 or a hydrocarbon group combining them. Examples of the alkyl group having the carbon number of 1 to 10 include a methyl group, an ethyl group, a propyl group and the like. Among them, the methyl group is preferable. Examples of the alkenyl group having the carbon number of 1 to 10 include a vinyl group, an allyl group and a butenyl group. Examples of the aryl group having the carbon number of 1 to 10 include a phenyl group.

However, at least one of R¹ and R² is the hydrocarbon group containing the substituted or unsubstituted alkenyl group having the carbon number of 1 to 10.

Further, R³ is a substituted or unsubstituted alkyl or aryl group having a carbon number of 1 to 8 or a hydrocarbon group combining them. Examples of the alkyl group having the carbon number of 1 to 8 include a methyl group, an ethyl group, a propyl group and the like. Among them, the methyl group is preferable. Examples of the aryl group having the carbon number of 1 to 8 include a phenyl group.

Further, in the formula (1), examples of a substituent group contained in R¹ and R² include a methyl group, a vinyl group and the like, and examples of a substituent group contained in R³ include a methyl group and the like.

In this regard, in the formula (1), R's are independent from each other, and may be different from each other or may be the same. Further, R²s and R³s are the same as R¹s.

Furthermore, each of “m” and “n” is the number of a repeating unit constituting the vinyl group-containing linear organopolysiloxane (A1) represented by the formula (1), “m” is an integer number of 1 to 1,000, and “n” is an integer number of 3,000 to 10,000. “m” is preferably in the range of 40 to 700, and “n” is preferably in the range of 3,600 to 8,000.

Further, examples of a concrete structure of the vinyl group-containing linear organopolysiloxane (A1) represented by the formula (1) include a structure represented by the following formula (1-1).

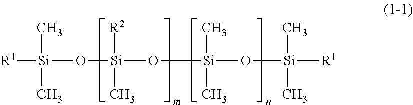

where in the formula (1-1), R¹ and R² are independently a methyl group or a vinyl group, and at least one of R¹ and R² is the vinyl group.

Moreover, it is preferred that the above vinyl group-containing linear organopolysiloxane (A1) contains a first vinyl group-containing linear organopolysiloxane (A1-1) containing a vinyl group in an amount of 0.05 to 0.2 mol % and a second vinyl group-containing linear organopolysiloxane (A1-2) containing a vinyl group in an amount of 0.5 to 12 mol %. By combining the first vinyl group-containing linear organopolysiloxane (A1-1) containing the vinyl group in a common amount with the second vinyl group-containing linear organopolysiloxane (A1-2) containing the vinyl group in a high amount as a raw rubber which is a raw material of the silicone rubber, it is possible to bias (ununiformly distribute) the vinyl groups in the silicone rubber-based curable composition, to thereby more effectively make different crosslink densities in the crosslink network of the silicone rubber. As a result, tearing strength of the silicone rubber can be more effectively improved.

Specifically, it is preferred that as the vinyl group-containing linear organopolysiloxane (A1), for example, a first vinyl group-containing linear organopolysiloxane (A1-1) represented by the formula (1-1) and containing an unit in which R¹ is the vinyl group and/or an unit in which R² is the vinyl group in an amount of 0.05 to 0.2 mol % and a second vinyl group-containing linear organopolysiloxane (A1-2) represented by the formula (1-1) and containing an unit in which R¹ is the vinyl group and/or an unit in which R² is the vinyl group in an amount of 0.5 to 12 mol % are used.

Further, the first vinyl group-containing linear organopolysiloxane (A1-1) preferably contains the vinyl group in an amount of 0.1 to 0.15 mol %. The second vinyl group-containing linear organopolysiloxane (A1-2) preferably contains the vinyl group in an amount of 0.8 to 8.0 mol %.

Furthermore, in the case where the first vinyl group-containing linear organopolysiloxane (A1-1) is mixed with the second vinyl group-containing linear organopolysiloxane (A1-2), a mixing ratio of (A1-1):(A1-2) is not limited to a specific value, but is preferably in the range of 1:0.05 to 1:0.6, and more preferably in the range of 1:0.08 to 1:0.5 in a weight ratio.

In this regard, as each of the first and second vinyl group-containing linear organopolysiloxane (A1-1) and (A1-2), one kind thereof may be used, and two or more kinds thereof may be also used in combination.

<Vinyl Group-Containing Branch Organopolysiloxane (A2)>

The vinyl group-containing branch organopolysiloxane (high vinyl hypoviscosity organopolysiloxane) (A2) is a component which forms an area having high crosslink density due to existence of the branch structure, to thereby largely contribute to form a coarseness and fineness structure having different crosslink densities in a silicone rubber system. Further, the vinyl group becomes the crosslinking point when the silicon rubber-based curable composition is cured. Therefore, it is possible to improve the tensile strength of the silicone rubber, while preventing hardness and modulus of the silicone rubber from becoming extremely high.

An amount of the vinyl group contained in the vinyl group-containing branch organopolysiloxane (A2) is not limited to a specific value, but is preferably in the range of 0.05 to 20.0 mol %, more preferably in the range of 0.1 to 12.0 mol %, and even more preferably in the range of 0.5 to 7.5 mol %. This makes it possible to optimize the amount of the vinyl group contained in the vinyl group-containing branch organopolysiloxane (A2), to thereby produce a silicone rubber having a high crosslink density. Therefore, it is possible to improve the tensile strength and tearing strength of the silicone rubber. Further, if the amount of the vinyl group exceeds the above mentioned upper limit value, there is a fear that the modulus of the silicone rubber becomes extremely high. On the other hand, if the amount of the vinyl group is lower than the above mentioned lower limit value, there is a fear that a stiffening effect due to the vinyl group-containing branch organopolysiloxane (A2) cannot be sufficiently obtained.

Even in the case of adding the vinyl group-containing branch organopolysiloxane (A2), 50% strain modulus of the silicone rubber is preferably 20% or less, more preferably 12% or less, and even more preferably 6% or less, from the viewpoint of preventing usability thereof from changing. If the 50% strain modulus exceeds 20%, there is a case that the usability of the silicone rubber obviously changes, to thereby have to adjust it.

A polymerization degree of the vinyl group-containing branch organopolysiloxane (A2) is preferably 4,000 or less, but there is no problem even if the polymerization degree exceeds 4,000. Since a vinyl group-containing branch organopolysiloxane (A2) having a polymerization degree of less than 4,000 is of a liquid or oil state, it is easily mixed with the other components constituting the silicon rubber-based curable composition. Although a vinyl group-containing branch organopolysiloxane (A2) having a polymerization degree of more than 4,000 has a high viscosity, it can be kneaded with the other components by being diluted with a solvent, or can be also kneaded with the other components by taking time without being diluted.

Further, a viscosity of the vinyl group-containing branch organopolysiloxane (A2) is preferably in the range of 4,000 to 70,000 cSt.

Furthermore, a specific gravity of the vinyl group-containing branch organopolysiloxane (A2) is not limited to a specific value, but preferably in the range of 0.95 to 1.1.

By using the vinyl group-containing branch organopolysiloxane (A2) having the polymerization degree, viscosity and specific gravity each falling within the above range, it is possible to improve the chemical reliability of the obtained molded body.

As the above mentioned vinyl group-containing branch organopolysiloxane (A2), preferable is an organopolysiloxane represented by the following average composition formula (d):

(CH₂═CH(R⁸)₂SiO_{1/2})ₘ(SiO_{4/2})ₙ (d).

In the formula (d), R⁸ is an univalent organic group containing no vinyl group, and preferably a substituted or unsubstituted alkyl or aryl group having a carbon number of 1 to 10 or a hydrocarbon group combining them. Examples of the alkyl group having the carbon number of 1 to 8 include a methyl group, an ethyl group, a propyl group and the like. Among them, the methyl group is preferable. Examples of the aryl group having the carbon number of 1 to 8 include a phenyl group. As R⁸, the methyl group is especially preferable.

Further, in the formula (d), “m” is the number of “CH₂═CH(R⁸)₂SiO_{1/2}” unit, and “n” is the number of “SiO_{4/2}” unit. The vinyl group-containing branch organopolysiloxane (A2) has a branch structure, and a ratio of “m” to “n” (m/n) is in the range of 2 to 5. m/n is preferable in the range of 3 to 4.

Concrete examples of the vinyl group-containing branch organopolysiloxane (A2) include an organopolysiloxane having a structure represented by the following formula (4).

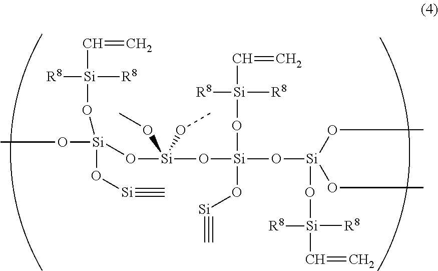

In the formula (4), R⁸ is a substituted or unsubstituted alkyl or aryl group having a carbon number of 1 to 8. Examples of the alkyl group having the carbon number of 1 to 8 include a methyl group, an ethyl group, a propyl group and the like. Among them, the methyl group is preferable. Examples of the aryl group having the carbon number of 1 to 8 include a phenyl group. Examples of a substituent group contained in R⁸ include a methyl group and the like.

In this regard, in formula (4), R⁸s are independent from each other, and may be different from each other or may be the same.

Further, in the formula (4), “—O—Si≡” represents that Si has a branch structure spreading in three dimension.

In this regard, as the vinyl group-containing branch organopolysiloxane (A2), one kind thereof may be used, and two or more kinds thereof may be also used in combination.

In the case where the vinyl group-containing organopolysiloxane (A) contains both the vinyl group-containing linear organopolysiloxane (A1) and the vinyl group-containing branch organopolysiloxane (A2) as described above, an area having high crosslink density and an area having low crosslink density are formed in the silicone rubber. A coarseness and fineness structure having different crosslink density areas is formed in the silicone rubber system. This makes it possible to further improve the tensile strength and tearing strength of the produced silicone rubber.

Further, a mixing ratio of the vinyl group-containing linear organopolysiloxane (A1):the vinyl group-containing branch organopolysiloxane (A2) is not limited to a specific value, but is preferably in the range of 1:0.001 to 1:0.4, more preferably in the range of 1:0.005 to 1:0.2, and even more preferably in the range of 1:0.01 to 1:0.1 in a weight ratio. This makes it possible to optimize the additive amount of the vinyl group-containing branch organopolysiloxane (A2) to the vinyl group-containing linear organopolysiloxane (A1). Therefore, it is also possible to optimize a size of the area having high crosslink density in the silicone rubber. As a result, the silicone rubber can exhibit excellent tensile strength and tearing strength.

<<Organohydrogen Polysiloxane (B)>>

An organohydrogen polysiloxane (B) is classified into a linear organohydrogen polysiloxane (B1) and a branch organohydrogen polysiloxane (B2). In the present invention, one of these linear organohydrogen polysiloxane (B1) and branch organohydrogen polysiloxane (B2) can be used alone, or both of them may be also used, but the mixture (B3) of the linear organohydrogen polysiloxane (B1) and the branch organohydrogen polysiloxane (B2) or the branch organohydrogen polysiloxane (B2) is preferably used alone.

<Linear Organohydrogen Polysiloxane (B1)>

The linear organohydrogen polysiloxane (B1) is a polymer having a linear structure and a structure (≡Si—H) in which a hydrogen atom is directly bonded to Si. This polymer reacts with a vinyl group contained in components to be mixed in the silicon rubber-based curable composition including the vinyl group of the vinyl group-containing organopolysiloxane (A) through hydrosilyl reaction, to thereby crosslink these components.

A molecular weight of the linear organohydrogen polysiloxane (B1) is not limited to a specific value, but a weight average molecular weight thereof is preferably 20,000 or less, and more preferably in the range of 1,000 to 10,000.

In this regard, the weight average molecular weight of the linear organohydrogen polysiloxane (B1) can be measured by using GPC (gel penetration chromatography).

Further, it is preferred that the linear organohydrogen polysiloxane (B1) generally has no vinyl group. This makes it possible to effectively prevent crosslink reaction from being progressed with a molecular of the linear organohydrogen polysiloxane (B1).

As the above mentioned linear organohydrogen polysiloxane (B1), a polysiloxane having a structure represented by the following formula (2) is preferably used.

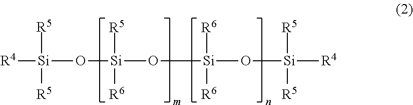

In the formula (2), R⁴ is a substituted or unsubstituted alkyl, alkenyl or aryl group having a carbon number of 1 to 10, a hydrocarbon group combining them or a hydrido group. Examples of the alkyl group having the carbon number of 1 to 10 include a methyl group, an ethyl group, a propyl group and the like. Among them, the methyl group is preferable. Examples of the alkenyl group having the carbon number of 1 to 10 include a vinyl group, an allyl group, a butenyl group and the like. Among them, the vinyl group is preferable. Examples of the aryl group having the carbon number 1 to 10 include a phenyl group.

Further, R⁵ is a substituted or unsubstituted alkyl, alkenyl or aryl group having a carbon number of 1 to 10, a hydrocarbon group combining them or a hydrido group. Examples of the alkyl group having the carbon number of 1 to 10 include a methyl group, an ethyl group, a propyl group and the like. Among them, the methyl group is preferable. Examples of the alkenyl group having the carbon number of 1 to 10 include a vinyl group, an allyl group, a butenyl group and the like. Among them, the vinyl group is preferable. Examples of the aryl group having the carbon number of 1 to 10 include a phenyl group.

In this regard, in the formula (2), R⁴s are independent from each other, and may be different from each other or may be the same. Further, R⁵s is the same as R⁴s. However, at least two of R⁴s and R⁵s are the hydrido groups.

Further, R⁶ is a substituted or unsubstituted alkyl or aryl group having a carbon number of 1 to 8 or a hydrocarbon group combining them. Examples of the alkyl group having the carbon number of 1 to 8 include a methyl group, an ethyl group, a propyl group and the like. Among them, the methyl group is preferable. Examples of the aryl group having the carbon number of 1 to 8 include a phenyl group. R⁶s are independent from each other, and may be different from each other or may be the same.

In this regard, examples of a substituent group contained in each of R⁴, R⁵ and R⁶ in the formula (2) include a methyl group, a vinyl and the like. Among them, the methyl group is preferable from the viewpoint of preventing intramolecular crosslink reaction.

Further, each of “m” and “n” is the number of a repeating unit constituting the linear organohydrogen polysiloxane (B1) represented by formula (2), “m” is an integer number of 0 to 300, and “n” is an integer number of (300-m). “m” is preferably in the range of 0 to 150, and “n” is preferably an integer number of (150-m).

In this regard, as the linear organohydrogen polysiloxane (B1), one kind thereof may be used, and two or more kinds thereof may be also used in combination.

<Branch Organohydrogen Polysiloxane (B2)>

The branch organohydrogen polysiloxane (B2) is a component which forms an area having high crosslink density due to existence of the branch structure, to thereby largely contribute to form a coarseness and fineness structure having different crosslink densities in a silicone rubber system. Further, like the above mentioned linear organohydrogen polysiloxane (B1), it is a polymer having a structure (≡Si—H) in which a hydrogen atom is directly bonded to Si. This polymer reacts with a vinyl group contained in components to be mixed in the silicon rubber-based curable composition including the vinyl group of the vinyl group-containing organopolysiloxane (A) through hydrosilylreaction, to thereby crosslink these components.

Further, a specific gravity of the branch organohydrogen polysiloxane (B2) is in the range of 0.9 to 0.95.

Furthermore, it is preferred that the branch organohydrogen polysiloxane (B2) generally has no vinyl group. This makes it possible to effectively prevent crosslink reaction from being progressed with a molecular of the branch organohydrogen polysiloxane (B2).

Further, as the branch organohydrogen polysiloxane (B2), preferable is an organohydrogen polysiloxane represented by the following average composition formula (c):

(Hₐ(R⁷)₃₋ₐSiO_{1/2})ₘ(SiO_{4/2})ₙ (C)

where in the formula (C), R⁷ is an univalent organic group, “a” is an integer number of 1 to 3, “m” is the number of “Hₐ(R⁷)₃₋ₐSiO_{1/2}” unit, and “n” is the number of “SiO_{4/2}” unit.

In the formula (c), R⁷ is the univalent organic group, but preferably a substituted or unsubstituted alkyl or aryl group having a carbon number of 1 to 10, or a hydrocarbon group combining them. Examples of the alkyl group having the carbon number of 1 to 10 include a methyl group, an ethyl group, a propyl group and the like. Among them, the methyl group is preferable. Examples of the aryl group having the carbon number of 1 to 10 include a phenyl group.

Further, in the formula (c), “a” is the number of the hydrido group (hydrogen atom directly bonded to Si), and an integer number of 1 to 3, but preferably “1”.

Further, in the formula (c), “m” is the number of the “Hₐ(R⁷)₃₋ₐSiO_{1/2}” unit, and “n” is the number of the “SiO_{4/2}” unit.

The branch organohydrogen polysiloxane (B2) has a branch structure. The linear organohydrogen polysiloxane (B1) and the branch organohydrogen polysiloxane (B2) are different from each other in that one of them has the linear structure whereas the other has the branch structure. In the case where the number of Si is defined as “1”, the number (R/Si) of the alkyl group “R” bonded to Si becomes in the range of 1.8 to 2.1 in the linear organohydrogen polysiloxane (B1), and the number (R/Si) becomes in the range of 0.8 to 1.7 in the branch organohydrogen polysiloxane (B2).

In this regard, since the branch organohydrogen polysiloxane (B2) has the branch structure, when it is heated under a nitrogen atmosphere, at a temperature raising rate of 10° C./min up to 1,000° C. to obtain a residue thereof, an amount of the residual becomes 5% or more. On the other hand, since the linear organohydrogen polysiloxane (B1) has the linear structure, when it is heated under the above condition, an amount of a residue thereof becomes approximately zero.

Further, concrete examples of the branch organohydrogen polysiloxane (B2) include an organohydrogen polysiloxane having a structure represented by the following formula (3).

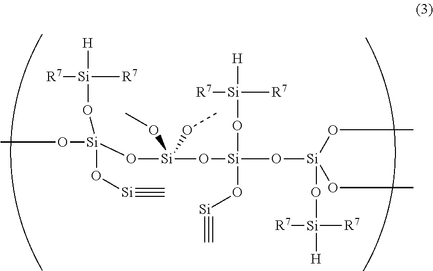

In the formula (3), R⁷ is a substituted or unsubstituted alkyl or aryl group having a carbon number of 1 to 8, a hydrocarbon group combining them or a hydrogen atom. Examples of the alkyl group having the carbon number of 1 to 8 include a methyl group, an ethyl group, a propyl group and the like. Among them, the methyl group is preferable. Examples of the aryl group having the carbon number of 1 to 8 include a phenyl group. Examples of a substituent group contained in R⁷ include a methyl group and the like.

In this regard, in the formula (3), R⁷s are independent from each other, and may be different from each other or may be the same.

Further, in the formula (3), “—O—Si≡” represents that Si has a branch structure spreading in three dimension.

In this regard, as the branch organohidrogen polysiloxane (B2), one kind thereof may be used, and two or more kinds thereof may be also used in combination.

Further, an amount of the hydrogen atom directly bonded to the Si (hydrido group), which is contained in each of the linear organohydrogen polysiloxane (B1) and the branch organohydrogen polysiloxane (B2), is not limited to a specific value. In the silicone rubber-based curable composition, a total amount of the hydrido group contained in the linear organohydrogen polysiloxane (B1) and the branch organohydrogen polysiloxane (B2) is preferably in the range of 0.5 to 5 mol, and more preferably in the range of 1 to 3.5 mol with respect to 1 mol of the vinyl group contained in the vinyl group-containing linear organopolysiloxane (A1). This makes it possible to reliably form a crosslink network between the linear organohydrogen polysiloxane (B1) and the branch organohydrogen polysiloxane (B2) and the vinyl group-containing linear organopolysiloxane (A1).

Out of the linear organohydrogen polysiloxane (B1) and the branch organohydrogen polysiloxane (B2), the linear organohydrogen polysiloxane (B1) is generally contained in the mixture (B3) (silicone rubber-based curable composition) as a major component thereof. As described above, the branch organohydrogen polysiloxane (B2) is used for forming the area having high crosslink density in the silicone rubber, to thereby improve the mechanical strength such as the tensile strength and the tearing strength thereof.

Therefore, in the case where the linear organohydrogen polysiloxane (B1) is mixed with the branch organohydrogen polysiloxane (B2), a ratio of (B1):(B2) is preferably in the range of 10:1 to 1:1, more preferably in the range of 5:1 to 2:1, and even more preferably in the range of 4:1 to 2:1 in a weight ratio. Specifically, the ratio of (B1):(B2) is adjusted to 0.42:0.14 or 0.35:0.12 in a weight ratio.

<<Silica Particles (C)>>

The silica particles (C) is a component to be added for improving the hardness and mechanical strength, especially, the tensile strength of the produced silicone rubber.

A specific surface area of this silica particles (C) is preferably in the range of about 50 to 400 m²/g, and more preferable in the range of about 100 to 400 m²/g. Further, an average particle size thereof is preferably in the range of about 1 to 100 nm, and more preferable in the range of about 5 to 20 nm.

By using the silica particles (C) having the specific surface area and average particle size each falling within the above range, it is possible for the silica particles (C) to conspicuously exhibit the above features thereof.

Examples of the silica particles (C) include fumed silica, baked silica, precipitated silica and the like.

In this regard, as the silica particles (C), one kind thereof may be used alone, and two or more kinds thereof may be also used in combination.

<<Silane Coupling Agent (D)>>

The silane coupling agent (D) preferably has a hydrolyzable group. In this case, the hydrolyzable group is hydrolyzed with water to product a hydroxyl group, and then such a hydroxyl group reacts with a hydroxyl group existing on the silica particles (C) through dehydration and condensation reaction. In this way, the silane coupling agent (D) can carry out a surface modification of the silica particles (C).

Further, this silane coupling agent (D) preferably has a hydrophobic group. This makes it possible to apply the hydrophobic group onto a surface of the silica particles (C), to thereby reduce cohesion force between the silica particles (C) (cohesion due to a hydrogen bond between the silanol groups) in the silicon rubber-based curable composition and the silicone rubber. As a result, it is conceived to improve dispersibility of the silica particles (C) in the composition.

For this reason, an area of a phase boundary between the silica particles (C) and a matrix formed of the silicone rubber increases, and thus a stiffening effect due to the silica particles (C) also increases. Further, it is conceived to improve slipperiness of the silica particles (C) in the matrix of the silicone rubber when being deformed. By improving the dispersibility and slipperiness of the silica particles (C), it is possible to impart excellent mechanical strength (e.g., tensile strength and tearing strength) to the silicone rubber by the silica particles (C) and to also make transparency thereof high.

Furthermore, the silane coupling agent (D) preferably has a vinyl group. This makes it possible to introduce the vinyl group onto the surface of the silica particles (C). Therefore, when the silicon rubber-based curable composition is cured, that is, when the vinyl group contained in the vinyl group-containing organopolysiloxane (A) reacts with the hydrido group contained in the organohydrogen polysiloxane (B) through the hydrosilylation reaction to form the network (crosslink structure) therebetween, the vinyl group contained in the silica particles (C) also reacts with the hydrido group contained in the organohydrogen polysiloxane (B) through the hydrosilylation reaction. Therefore, the silica particles (C) are also incorporated in the network of the silicone rubber. This makes it possible to further improve the hardness and modulus of the produced silicone rubber.

In the case where the silicone rubber is used as a material of a medical catheter, the silicone rubber is required to have a certain degree of hardness. For example, if a catheter is formed of a material having low hardness, it is easy to cause problems such as deformation (so-called bend) due to insertion resistance when inserting the catheter into a purpose part (e.g., thoracic cavity) and occlusion of a lumen thereof due to a low anti-kink property. On the other hand, by making the hardness and modulus of the silicone rubber high, the above problems can be resolved in the catheter formed of such a silicone rubber.

Examples of such a silane coupling agent (D) include a coupling agent represented by the following formula (5):

Yₙ—Si—(OR)₄₋ₙ (5)

where in the formula (5), “n” is an integer number of 1 to 3. “Y” is a functional selected from the group consisting of a hydrophobic group, a hydrophilic group and a vinyl group. In the case where “n” is “1”, “Y” is the hydrophobic group, and in the case where “n” is “2” or “3”, at least one of “Y”s is the hydrophobic group. “OR” is a hydrolysable group.

The hydrophobic group is an alkyl or aryl group having a carbon number of 1 to 6 or a hydrocarbon group combining them. Examples thereof include a methyl group, an ethyl group, a propyl group, a phenyl and the like. Among them, the methyl group is especially preferable.

Further, examples of the hydrophilic group include a hydroxyl group, a sulfonic acid group, a carboxyl group, a carbonyl group and the like. Among them, the hydroxyl group is especially preferable. In this regard, the hydrophilic group may be contained as the functional group, but preferably is not contained from the viewpoint of imparting hydrophobicity to the silane coupling agent (D).

Furthermore, examples of the hydrolysable group include an alkoxy group such as a methoxy group or an ethoxy group, a chloro group, a silazane group and the like. Among them, the silazane group is preferable. This is because the silazane group has high reactivity with the silica particles (C). In this regard, a silane coupling agent (D), which has the silazane group as the hydrolysable group, has two structures (Yₙ—Si—) in the above formula (5) from a structural characteristic thereof.

Concrete examples of the silane coupling agent (D) represented by the above formula (5) include the following compounds. Examples of the silane coupling agent (D) having the hydrophobic group include an alkoxysilane such as methyl trimethoxysilane, dimethyl dimethoxysilane, phenyl trimethoxysilane, methyl triethoxysilane, dimethyl diethoxysilane, phenyl triethoxysilane, n-propyl trimethoxysilane, n-propyl triethoxysilane, hexyl triethoxysilane or decile trimethoxysilane; a chlorosilane such as methyl trichlorosilane, dimethyl dichlorosilane, trimethyl chlorosilane or phenyl trichlorosilane; and hexamethyl disilazane.

Further, examples of the silane coupling agent (D) having the vinyl group as the functional group include an alkoxysilane such as methacryloxypropyl triethoxysilane, methacryloxypropyl trimethoxysilane, methacryloxypropyl methyl diethoxysilane, methacryloxypropyl methyl dimethoxysilane, vinyl triethoxysilane, vinyl trimethoxysilane or vinyl methyl dimethoxysilane; a chlorosilane such as vinyl trichlorosilane, vinyl methyl dichlorosilane; and divinyl tetramethyl disilazane.

Among them, the hexamethyl disilazane is preferable as the silane coupling agent (D) having the hydrophobic group, and the divinyl tetramethyl disilazane is preferable as the silane coupling agent (D) having the vinyl group, when considering the above description.

<<Platinum or Platinum Compound (E)>>

The platinum or platinum-compound (E) is a component serving as a catalyst when curing the silicon rubber-based curable composition (polymerizable components), and is contained therein in a catalytic amount.

As the platinum or platinum compound (E), a known substance can be used. Examples of the platinum or platinum compound (E) include platinum black-supported or platinum-supported silica, carbon black and the like, chloroplatinic acid, an alcohol solution of chloroplatinic acid, a complex salt of chloroplatinic acid and olefin, a complex salt of chloroplatinic acid and vinyl siloxane, and the like.

In this regard, as the platinum or platinum compound (E), one kind thereof may be used alone, and two or more kinds thereof may be also used in combination.

<<Water (F)>>

Further, the silicon rubber-based curable composition of the present invention may contain a water (F) in sedition to the above components (A) to (E).

The water (F) is a component which functions as a dispersion medium for dispersing each component contained in the silicon rubber-based curable composition and contributes for the reaction of the silica particles (C) with the silane coupling agent (D).

Furthermore, the silicon rubber-based curable composition of the present invention may contain known components which are added to the silicon rubber-based curable composition in addition to the above components (A) to (F). Examples of such known components include diatomite, ferric oxide, zinc oxide, titanium oxide, barium oxide, magnesium oxide, ceric oxide, calcium carbonate, magnesium carbonate, zinc carbonate, glass wool, mica and the like. Besides, the silicon rubber-based curable composition may appropriately contain a dispersant, a pigment, a dye, an antistatic agent, an antioxidant, a flame retardant, a transcalency improver and the like.

In this regard, in the silicon rubber-based curable composition, a mixing ratio of each component is not limited to a specific value, but is, for example, adjusted as follows.

Namely, an amount of the silica particles (C) contained in the silicon rubber-based curable composition is preferably in the range of 10 to 100 parts by weight, and more preferably in the range of 35 to 75 parts by weight with respect to 100 parts by weight of total of the vinyl group-containing organopolysiloxane (A) and the organohydrogen polysiloxane (B). This makes it possible to reliably improve the tensile strength of the silicone rubber up to a desired range.

An amount of the silane coupling agent (D) contained in the silicon rubber-based curable composition is preferably in the range of 5 to 100 parts by weight, and more preferably in the range of 10 to 40 parts by weight with respect to 100 parts by weight of the silica particles (C). This makes it possible to reliably improve the dispersibility of the silica particles (C) in the silicon rubber-based curable composition.

An amount of the platinum or platinum compound (E) contained in the silicon rubber-based curable composition means the catalytic amount, and it can be appropriately adjusted. Specifically, the amount is preferably in the range of 0.01 to 5 parts by weight, and more preferably in the range of 0.02 to 0.2 parts by weight with respect to 100 parts by weight of the total of the vinyl group-containing organopolysiloxane (A) and the organohydrogen polysiloxane (B). This makes it possible to further reliably progress the reaction of the vinyl group-containing organopolysiloxane (A) with the organohydrogen polysiloxane (B).

Further, in the case where the silicon rubber-based curable composition contains the water (F), an amount of the water (F) contained therein can be appropriately adjusted. Specifically, the amount is preferably in the range of 10 to 100 parts by weight, and more preferably in the range of 30 to 70 parts by weight with respect to 100 parts by weight of the silane coupling agent (D). This makes it possible to further reliably progress the reaction of the silane coupling agent (D) with the silica particles (C).

The silicon rubber-based curable composition having the above formulation contains the silica particles (C) and the silane coupling agent (D). Therefore, in the silicon rubber-based curable composition, the surface modification of the silica particles (C) progresses by the silane coupling agent (D). This makes it possible to improve the dispersibility of the silica particles (C) in the silicon rubber-based curable composition in a stepwise fashion. For this reason, it is conceived to improve the strength (tensile strength and tearing strength) of the silicone rubber produced by curing the silicon rubber-based curable composition.

For example, a silicon rubber-based curable composition having the above formulation and a silicone rubber are produced as follows.

Hereinafter, description will be made on a case where the silicon rubber-based curable composition is prepared, and then the silicone rubber is produced by curing such a silicon rubber-based curable composition.

<Method of Producing Silicone Rubber>

The silicone rubber can be produced by uniformly mixing the above respective components with each other by using any kneading machine to prepare the silicon rubber-based curable composition, and then curing this silicone rubber by being heated. However, the silicone rubber can be also produced through the following steps. This makes it possible to produce a silicone rubber having excellent strength.

[1] First, the vinyl group-containing linear organopolysiloxane (A1), the silica particles (C) and the silane coupling agent (D) are weighed at predetermined amounts, and then kneaded by using any kneading machine, to thereby obtain a kneaded product containing the above components (A1), (C) and (D).

In this regard, it is preferred that the kneaded product is obtained by kneading the vinyl group-containing linear organopolysiloxane (A1) and the silane coupling agent (D) in advance, and then kneading the silica particles (C) thereto. This makes it possible to further improve the dispersibility of the silica particles (C) in the vinyl group-containing linear organopolysiloxane (A1) (main component).

Further, when obtaining this kneaded product, the water (F) may be added to the respective components (A1), (C) and (D) as needed.

Furthermore, it is preferred that the kneading of these components (A1), (C) and (D) is carried out through a first step of heating them at a first temperature and a second step of heating them at a second temperature. In this case, the surface of the silica particles (C) can be subjected to a surface treatment with the coupling agent (D) during the first step, and by-products generated by reactionng the silica particles (C) with the coupling agent (D) can be reliably removed from the kneaded product during the second step.

The first temperature is preferably in the range of about 40 to 120° C., and more preferably in the range of about 60 to 90° C. The second temperature is preferably in the range of about 130 to 210° C., and more is preferably in the range of about 160 to 180° C.

An atmosphere of the first step is preferably an inert atmosphere such as a nitrogen atmosphere, and an atmosphere of the second step is preferably a decompression atmosphere.

Further, a time of the first step is preferably in the range of about 0.3 to 1.5 hours, and more preferably in the range of about 0.5 to 1.2 hours. A time of the second step is preferably in the range of about 0.7 to 3.0 hours, and more preferably in the range of about 1.0 to 2.0 hours.

By carrying out the first step and the second step under the above condition, it is possible to more conspicuously exhibit the above mentioned effects.

[2] Next, the vinyl group-containing branch organopolysiloxane (A2), the mixture (B3) of the linear organohydrogen polysiloxane (B1) and the branch organohydrogen polysiloxane (B2) or the branch organohydrogen polysiloxane (B2), and the platinum or platinum compound (E) are weighed at predetermined amounts, and then these components (A2), (B3) or (B2) and (E) are kneaded with the kneaded product prepared in the step [1] by using any kneading machine, to thereby obtain the silicone rubber-based curable composition.

In this regard, it is preferred that when the components (A2), (B3) or (B2) and (E) are kneaded, a part of the kneaded product prepared in the step [1] in advance is kneaded with the vinyl group-containing branch organopolysiloxane (A2) and the mixture (B3) or the branch organohydrogen polysiloxane (B2), and the other part of the kneaded product prepared in the step [1] is kneaded with the platinum or platinum compound (E), and then both the kneaded products are kneaded with each other. This makes it possible to reliably disperse the respective components (A) to (E) in the silicon rubber-based curable composition, without progressing the reaction of the vinyl group-containing organopolysiloxane (A) ((A1) and/or (A2)) with the organohydrogen polysiloxane (B) ((B1) and/or (B2)).

A temperature of kneading the respective components (B3) or (B2) and (E) with each other is preferably in the range of about 10 to 70° C., and more preferably in the range of about 25 to 30° C. as a roll setting temperature.

Further, a kneading time is preferably in the range of about 5 minutes to 1 hour, and more preferably in the range of about 10 to 40 minutes.

By setting the temperature within the above range, it is possible to more reliably prevent or suppress the reaction of the vinyl group-containing organopolysiloxane (A) ((A1) and/or (A2)) with the organohydrogen polysiloxane (B) ((B1) and/or (B2)) from progressing. Further, by setting the kneading time within the above range, it is possible to more reliably disperse the respective components (A) to (E) in the silicon rubber-based curable composition.

In this regard, the kneading machine used in each of the steps [1] and [2] is not limited to a specific type. As the kneading machine, a kneader, a biaxial roll, a Banbury mixer (continuation kneader), a pressurization kneader or the like can be used.

Further, a reaction inhibitor such as 1-ethynyl cyclohexanol may be added to the kneaded product in this step [2]. This makes it possible to more effectively prevent or suppress the reaction of the vinyl group-containing organopolysiloxane (A) ((A1) and/or (A2)) with the organohydrogen polysiloxane (B) ((B1) and/or (B2)) from progressing even if the temperature of the kneaded product is adjusted to a relatively high temperature.

[3] Next, the silicone rubber is produced by curing the silicon rubber-based curable composition.

For example, the silicon rubber-based curable composition is cured by being heated (first-cured) at 140 to 180° C. for 5 to 15 minutes, and then post-baked (second-cured) at 200° C. for 4 hours.

Through the above steps, the silicone rubber is obtained.

Further, by using the above mentioned silicone rubber, it is possible to obtain a molded body having excellent mechanical strength.

Furthermore, by using such a molded body, it is possible to obtain a medical tube, medical sealing agent, packing agent and keypad each made of the silicone rubber.

Especially, by using a molded body brought into a tubular shape as the medical tube, this medical tube exhibits an excellent anti-kink property, scratch resistance and insertability, and have high transparency.

In this regard, the anti-kink property relates to the tensile strength and hardness, and the insertability relates to the tensile strength.

Further, since change of 50% strain modulus of the above silicone rubber is small, it can exhibit superior tensile strength without changing usability thereof.

In this embodiment, in the steps [1] and [2], the silicon rubber-based curable composition is prepared by obtaining the kneaded product containing the vinyl group-containing linear organopolysiloxane (A1), the silica particles (C) and the silane coupling agent (D), and then kneading the vinyl group-containing branch organopolysiloxane (A2), the organohydrogen polysiloxane (B) ((B3) or (B2)) and the platinum or platinum compound (E) with the kneaded product, but is not limited thereto.

For example, the silicon rubber-based curable composition may be prepared by obtaining the kneaded product containing the vinyl group-containing linear organopolysiloxane (A1), the vinyl group-containing branch organopolysiloxane (A2), the silica particles (C) and the silane coupling agent (D), and then kneading the organohydrogen polysiloxane (B) ((B3) or (B2)) and the platinum or platinum compound (E) with the kneaded product. A silicone rubber produced by using the silicon rubber-based curable composition prepared in this way can also exhibit the same effects as the silicone rubber produced by using the silicon rubber-based curable composition prepared through the above mentioned steps [1] and [2].

Hereinabove, the silicon rubber-based curable composition, the method of producing the silicone rubber, the silicone rubber, the molded body and the medical tube according to the present invention are described, but are not limited thereto.

For example, in the silicon rubber-based curable composition, the method of producing the silicone rubber, the silicone rubber, the molded body and the medical tube according to the present invention, any components capable of exhibiting the same functions as the above components may be added.

### EXAMPLES

Next, concrete examples of the present invention will be described.

In this regard, the present invention is not restricted by descriptions of the concrete examples.

### 1. Preparation of Raw Material

First, raw materials used in Examples and Reference Examples are shown below.

(1) First vinyl group-containing linear organopolysiloxane (A1-1) (an amount of vinyl group contained therein was 0.13 mol %; low vinyl rubber): It was synthesized by the following synthetic scheme.

(2) Second vinyl group-containing linear organopolysiloxane (A1-2) (an amount of vinyl group contained therein was 0.92 mol %; high vinyl rubber): It was synthesized by the following synthetic scheme.

(3) Vinyl group-containing branch organopolysiloxane (A2): prepared was “VQM-135” produced by GELEST Inc.

(4) Linear organohydrogen polysiloxane (B1): prepared was “88466” produced by MOMENNTIVE Inc.

(5) Branch organohydrogen polysiloxane (B2): prepared was “HQM-105” produced by GELEST Inc.

(6) Silica particle (C): silica fine particles (a specific surface area thereof was 300 m²/g), prepared was “AEROSIL300” produced by Japan AEROSIL Inc.

(7) Silane coupling agent (D1): hexamethyl disilazane (HMDZ), prepared was “HEXAMETHYL DISILAZANE (SIH6110.1)” produced by Gelst Inc.

(8) Silane coupling agent (D2): Divinyl tetramethyl disilazane, prepared was “1,3-DIVINYL TETRAMETHYL DISILAZANE (SID4612.0)” produced by Gelst Inc.

(9) Platinum or platinum compound (E): Platinum compound, prepared was “PLATINUM DIVINYL TETRAMETHYL DISILOXANE COMPLEX in xylene (SIP6831.2)” produced by Gelest Inc.

[Synthesis of First Vinyl Group-Containing Linear Organopolysiloxane (A1-1)]

The first vinyl group-containing linear organopolysiloxane was synthesized according to the following formula (6).

74.7 g (252 mmol) of octamethyl cyclotetrasiloxane, 0.086 g (0.25 mmol) of 2,4,6,8-tetramethyl 2,4,6,8-tetravinyl cyclotetrasiloxane and 0.1 g of potassium siliconate were put into a 300 mL separable flask replaced by an Ar gas and provided with a condenser tube and a stirring wing, heated and stirred at 120° C. for minutes. At this time, it was confirmed that a viscosity of a mixture increased.

Thereafter, a temperature of the mixture was raised up to 155° C., and continuously stirred for 3 hours. After 3 hours, 0.1 g (0.6 mmol) of 1,3-divinyl tetramethyl disiloxane was added thereto, and further stirred at 155° C. for 4 hours.

Further, after 4 hours, the mixture was diluted with 250 mL of toluene, and then washed three times with water. A washed organic layer was washed several times with 1.5 L of methanol, to obtain a separated oligomer and polymer by being reprecipitated and purified. The obtained polymer was dried under reduced pressure at 60° C. overnight, to thereby obtain the first vinyl group-containing linear organopolysiloxane (A1-1) (Mn=277,734, Mw=573,906, IV value (dl/g)=0.89).

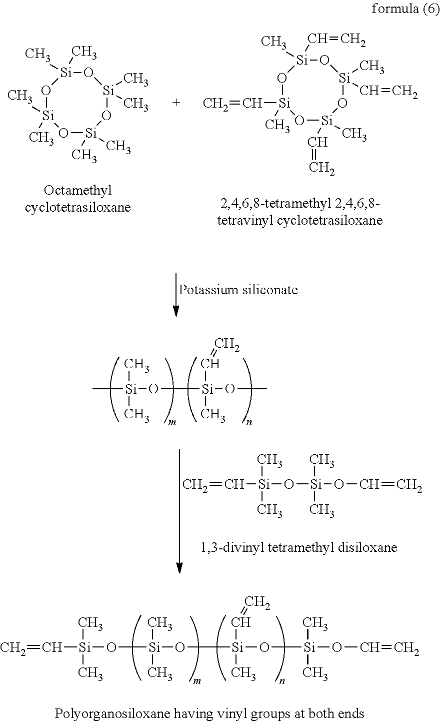

[Synthesis of Second Vinyl Group-Containing Linear Organopolysiloxane (A1-2)]

The second vinyl group-containing linear organopolysiloxane (A1-2) was synthesized in the same manner as the above synthesis of (A1-1), except that 0.86 g (2.5 mmol) of the 2,4,6,8-tetramethyl 2,4,6,8-tetravinyl cyclotetrasiloxane was used.

### 2. Preparation of Silicon Rubber-Based Curable Composition

### Example 1A

First, 10 parts by weight of the hexamethyl disilazane (D1), 0.5 parts by weight of the divinyl tetramethyl disilazane (D2) and 5.25 parts by weight of water (F) were kneaded with 100 parts by weight of the vinyl group-containing linear organopolysiloxane (A1) [(A1-1):(A1-2)=80 parts by weight:20 parts by weight] in advance, and then 55 parts by weight of the silica particles (C) was added thereto and kneaded with each other, to thereby obtain a kneaded product (silicone rubber compound).

In this regard, after adding the silica particles (C), the kneading was carried out through a first step for coupling reaction in which an atmosphere was set to a nitrogen atmosphere, a temperature was set to 60 to 90° C. and a time was set to 1 hour, and a second step for by-product (ammonia) removal in which an atmosphere was set to a reduced pressure, a temperature was set to 160 to 180° C. and a time was set to 2 hours.

Further, the obtained kneaded product was cooled down to room temperature.

Next, 1.04 parts by weight of the vinyl group-containing branch organopolysiloxane (A2), 0.34 parts by weight of the branch organohydrogen polysiloxane (B2) and 0.05 parts by weight of the platinum (E) as additives were added to 100 parts by weight of the kneaded product, and then kneaded with each other by using rolls, to thereby prepare a silicone rubber-based curable composition.

### Examples 2A to 6A

Each of silicon rubber-based curable compositions was prepared in the same manner as Example 1A, except that the mixing amounts of the vinyl group-containing branch organopolysiloxane (A2) and the branch organohydrogen polysiloxane (B2) were changed as shown in table 1.

### Examples 7A and 8A

Each of silicon rubber-based curable compositions was prepared in the same manner as Example 1A, except that the mixing amount of the vinyl group-containing branch organopolysiloxane (A2) was changed as shown in table 1, and the linear organohydrogen polysiloxane (B1) was used in a mixing amount shown in Table 1 instead of the branch organohydrogen polysiloxane (B2).

### Reference Examples 1A and 2A

Each of silicon rubber-based curable compositions was prepared in the same manner as Example 1A, except that the mixing of the vinyl group-containing branch organopolysiloxane (A2) was omitted, and the mixing amount of the branch organohydrogen polysiloxane (B2) was changed as shown in table 1.

### Reference Example 3A

A silicon rubber-based curable composition was prepared in the same manner as Example 1A, except that the mixing of the vinyl group-containing branch organopolysiloxane (A2) was omitted, and the linear organohydrogen polysiloxane (B1) was used in a mixing amount shown in Table 1 instead of the branch organohydrogen polysiloxane (B2).

### Example 1B

First, 10 parts by weight of the hexamethyl disilazane (D1), 0.5 parts by weight of the divinyl tetramethyl disilazane (D2) and 5.25 parts by weight of water (F) were kneaded with 100 parts by weight of the vinyl group-containing linear organopolysiloxane (A1) [(A1-1):(A1-2)=80 parts by weight:20 parts by weight] and 1.04 parts by weight of the vinyl group-containing branch organopolysiloxane (A2) in advance, and then 55 parts by weight of the silica particles (C) was added thereto and kneaded with each other, to thereby obtain a kneaded product (silicone rubber compound).

In this regard, after adding the silica particles (C), the kneading was carried out through a first step for coupling reaction in which an atmosphere was set to a nitrogen atmosphere, a temperature was set to 60 to 90° C. and a time was set to 1 hour, and a second step for by-product (ammonia) removal in which an atmosphere was set to a reduced pressure, a temperature was set to 160 to 180° C. and a time was set to 2 hours.

Further, the obtained kneaded product was cooled down to room temperature.

Next, 0.33 parts by weight of the branch organohydrogen polysiloxane (B2) and 0.05 parts by weight of the platinum (E) were added to 100 parts by weight of the kneaded product, and then kneaded with each other by using rolls, to thereby obtain a silicone rubber-based curable composition.

### Examples 2B to 4B

Each of silicon rubber-based curable compositions was prepared in the same manner as Example 1B, except that the mixing amounts of the vinyl group-containing branch organopolysiloxane (A2) and the branch organohydrogen polysiloxane (B2) were changed as shown in table 2.

### Examples 5B and 6B

Each of silicon rubber-based curable compositions was prepared in the same manner as Example 1B, except that the mixing amounts of the vinyl group-containing branch organopolysiloxane (A2) and the branch organohydrogen polysiloxane (B2) were changed as shown in table 2, and the linear organohydrogen polysiloxane (B1) was used in a mixing amount shown in Table 2 in addition to the branch organohydrogen polysiloxane (B2).

### Reference Examples 1B to 4B

Each of silicon rubber-based curable compositions was prepared in the same manner as Example 1B, except that the linear organohydrogen polysiloxane (B1) was used in a mixing amount shown in Table 2 instead of the branch organohydrogen polysiloxane (B2), and the mixing amount of the silica particles (C) was changed as shown in Table 2.

### 3. Evaluation

The silicon rubber-based curable composition obtained in each of Examples and Reference Examples was evaluated as follows.

3-1. Evaluation of Tensile Strength, Stretch at Break, 50% Strain Modulus, Tearing Strength and Stroke

The silicon rubber-based curable composition obtained in each of Examples and Reference Examples was pressed at 170° C. and 10 MPa for 10 minutes to form into a sheet having a thickness of 1 mm and primary-cure it. Subsequently, the sheet was heated at 200° C. for 4 hours to secondary-cure it.

By using the obtained sheet-like silicone rubber, formed were a dumbbell third-type specimen based on JIS K6251(2004) and a crescent specimen based on JIS K6252(2001). Measured were tensile strength, stretch at break and 50% strain modulus of the dumbbell third-type specimen based on JIS K6251(2004), and tearing strength and stroke of the crescent specimen based on JIS K6252(2001).

In the regard, a thickness of the specimen used in each of the measurement of the tensile strength, stretch at break, 50% strain modulus, tearing strength and stroke was 1 mm.

3-2. Evaluation of Hardness

By using the silicon rubber-based curable composition obtained in each of Examples and Reference Examples, a sheet-like silicone rubber was produced in the same manner as the measurement of the tensile strength, distortion, tearing strength and stroke, and then a type A durometer hardness thereof was measured based on JIS K6253(1997). A specimen was formed by laminating sheets each having a thickness of 1 mm together so that a total thickness thereof became 6 mm or more.

3-3. Evaluation of Total Light Transmittance and Haze Value

Total light transmittance and a haze value were measured by using an integrating sphere-type total light transmittance measuring apparatus (“NDH2000” produced by NIPPON DENSHOKU INDUSTRIES CO., LTD.) based on JIS K 7105, measuring method A. A thickness of a specimen used for the measurement was 1 mm.

Evaluation results of the silicon rubber-based curable composition obtained in each of Examples and Reference Examples as described above are shown in the following Tables 1 and 2, respectively.

TABLE 1

| | | Ex. 1A | Ex. 2A | Ex. 3A | Ex. 4A | Ex. 5A | Ex. 6A |
|---|---|---|---|---|---|---|---|
| Kneaded | (A1) Vinyl group-containing linear | | | | | | |
| product | organopolysiloxane | | | | | | |
| component | (A1-1) Low vinyl rubber | 80 | 80 | 80 | 80 | 80 | 80 |
| [parts by | (A1-2) High vinyl rubber | 20 | 20 | 20 | 20 | 20 | 20 |
| weight] | (C) Silica particles | 55 | 55 | 55 | 55 | 55 | 55 |
| | (D) Silane coupling agent | | | | | | |
| | (D1) Hexamethyl disilazane | 10 | 10 | 10 | 10 | 10 | 10 |
| | (D2) Divinyl tetramethyl disilazane | 0.5 | 0.5 | 0.5 | 0.5 | 0.5 | 0.5 |
| | (F) Water | 5.25 | 5.25 | 5.25 | 5.25 | 5.25 | 5.25 |
| Additive | (A2) Vinyl group-containing | 1.04 | 2.08 | 4.16 | 1.04 | 2.08 | 4.16 |
| component | branch organopolysiloxane | | | | | | |
| [parts by | (B) Organohydrogen polysiloxane | | | | | | |
| weight] | (B1) Linear organohydrogen | 0 | 0 | 0 | 0 | 0 | 0 |
| | polysiloxane | | | | | | |
| | (B2) Branch organohydrogen | 0.34 | 0.37 | 0.43 | 0.25 | 0.28 | 0.32 |
| | polysiloxane | | | | | | |
| | (E) Platinum catalyst | 0.05 | 0.05 | 0.05 | 0.05 | 0.05 | 0.05 |
| Key | (C) Silica particles | 32.2 | 32.2 | 32.2 | 32.2 | 32.2 | 32.2 |
| component | (B) Molecular type of organohydrogen | Branch | Branch | Branch | Branch | Branch | Branch |
| | polysiloxane | | | | | | |
| | [CH2CH] of (A1 + A2)/[CH2CH] of (A1) | 1.1 | 1.2 | 1.4 | 1.1 | 1.2 | 1.4 |
| | [H]/[CH2CH] | 1 | 1 | 1 | 0.75 | 0.75 | 0.75 |
| Evaluation | Tensile strength [MPa] | 9.4 | 9.8 | 10 | 7.4 | 7.9 | 8.7 |
| | Stretch at break [%] | 1317 | 1567 | 1351 | 2079 | 1953 | 1943 |
| | Tearing strength [N/mm²] | 49.8 | 48.8 | 48.5 | 48.5 | 51.2 | 53.2 |
| | Stroke at break [mm] | 198 | 217 | 176 | 437 | 390 | 376 |
| | 50% strain modulus [MPa] | 0.56 | 0.59 | 0.59 | 0.39 | 0.39 | 0.38 |
| | Hardness | 56.3 | 52.7 | 54.7 | 44 | 45.8 | 48 |
| | Total light transmittance (1 mm thickness) | 89.2 | 89.2 | 89.8 | 88.8 | 89.5 | 89.2 |
| | Haze value | 9.2 | 8.2 | 7 | 9 | 8.6 | 8.1 |

| | | Ex. 7A | Ex. 8A | Ref. 1A | Ref. 2A | Ref. 3A |
|---|---|---|---|---|---|---|
| Kneaded | (A1) Vinyl group-containing linear | | | | | |
| product | organopolysiloxane | | | | | |
| component | (A1-1) Low vinyl rubber | 80 | 80 | 80 | 80 | 80 |
| [parts by | (A1-2) High vinyl rubber | 20 | 20 | 20 | 20 | 20 |
| weight] | (C) Silica particles | 55 | 55 | 55 | 55 | 55 |
| | (D) Silane coupling agent | | | | | |
| | (D1) Hexamethyl disilazane | 10 | 10 | 10 | 10 | 10 |
| | (D2) Divinyl tetramethyl disilazane | 0.5 | 0.5 | 0.5 | 0.5 | 0.5 |
| | (F) Water | 5.25 | 5.25 | 5.25 | 5.25 | 5.25 |
| Additive | (A2) Vinyl group-containing | 3.73 | 6.03 | 0 | 0 | 0 |
| component | branch organopolysiloxane | | | | | |
| [parts by | (B) Organohydrogen polysiloxane | | | | | |
| weight] | (B1) Linear organohydrogen | 0.52 | 0.6 | 0 | 0 | 0.38 |
| | polysiloxane | | | | | |
| | (B2) Branch organohydrogen | 0 | 0 | 0.31 | 0.23 | 0 |
| | polysiloxane | | | | | |
| | (E) Platinum catalyst | 0.05 | 0.05 | 0.05 | 0.05 | 0.05 |
| Key | (C) Silica particles | 32.2 | 32.2 | 32.2 | 32.2 | 32.2 |
| component | (B) Molecular type of organohydrogen | Linear | Linear | Branch | Branch | Linear |
| | polysiloxane | | | | | |
| | [CH2CH] of (A1 + A2)/[CH2CH] of (A1) | 1.4 | 1.6 | 1 | 1 | 1 |
| | [H]/[CH2CH] | 1 | 1 | 1 | 0.75 | 1 |
| Evaluation | Tensile strength [MPa] | 8 | 8.2 | 9.2 | 7.5 | 6.3 |
| | Stretch at break [%] | 1641 | 1759 | 1632 | 2086 | 1923 |
| | Tearing strength [N/mm²] | 51.5 | 51 | 49.5 | 48.1 | 45 |
| | Stroke at break [mm] | 288 | 305 | 257 | 380 | 407 |
| | 50% strain modulus [MPa] | 0.53 | 0.54 | 0.53 | 0.38 | 0.51 |
| | Hardness | 52.7 | 50.8 | 49.8 | 46.3 | 47.1 |
| | Total light transmittance (1 mm thickness) | 88.6 | 89.5 | 89.5 | 87.6 | 89.6 |
| | Haze value | 9.43 | 9.64 | 9.4 | 22.6 | 13.6 |

TABLE 2

| | | Ex. 1B | Ex. 2B | Ex. 3B | Ex. 4B | Ex. 5B | Ex. 6B |
|---|---|---|---|---|---|---|---|
| Kneaded | (A1) Vinyl group-containing linear | | | | | | |
| product | organopolysiloxane | | | | | | |
| component | (A1-1) Low vinyl rubber | 80 | 80 | 80 | 80 | 80 | 80 |
| [parts by | (A1-2) High vinyl rubber | 20 | 20 | 20 | 20 | 20 | 20 |
| weight] | (C) Silica particles | 55 | 55 | 55 | 55 | 55 | 55 |
| | (D) Silane coupling agent | | | | | | |
| | (D1) Hexamethyl disilazane | 10 | 10 | 10 | 10 | 10 | 10 |
| | (D2) Divinyl tetramethyl disilazane | 0.5 | 0.5 | 0.5 | 0.5 | 0.5 | 0.5 |
| | (F) Water | 5.25 | 5.25 | 5.25 | 5.25 | 5.25 | 5.25 |
| | (A2) Vinyl group-containing | 1.04 | 2.08 | 1.04 | 1.04 | 2.08 | 1.04 |
| | branch organopolysiloxane | | | | | | |
| Additive | (B) Organohydrogen polysiloxane | | | | | | |
| component | (B1) Linear organohydrogen | 0 | 0 | 0 | 0 | 0.35 | 0.42 |
| [parts by | polysiloxane | | | | | | |
| weight] | (B2) Branch organohydrogen | 0.33 | 0.44 | 0.47 | 0.31 | 0.12 | 0.14 |
| | polysiloxane | | | | | | |
| | (E) Platinum catalyst | 0.05 | 0.05 | 0.05 | 0.05 | 0.05 | 0.05 |
| Evaluation | Tensile strength [MPa] | 9.4 | 8.4 | 9.7 | 9.2 | 9 | 10.3 |
| | Stretch at break [%] | 1219 | 1968.2 | 941.1 | 1632.4 | 1488.8 | 1299.9 |
| | Tearing strength [N/mm²] | 57 | 50.7 | 46.6 | 49.5 | 51.2 | 52.8 |
| | Stroke at break [mm] | 215.3 | 336.6 | 110.9 | 256.6 | 221.7 | 172.2 |
| | 50% strain modulus [MPa] | 1.08 | 0.62 | 1.41 | 0.88 | 1.05 | 1.23 |
| | Hardness | 53.2 | 45.8 | 59.5 | 49.8 | 49.7 | 53.8 |
| | Total light transmittance (1 mm thickness) | 88 | 87.8 | 87.3 | 89.5 | 88.7 | 88.5 |
| | Haze value | 12.1 | 11 | 14.6 | 9.4 | 14.2 | 14.6 |

| | | Ref. 1B | Ref. 2B | Ref. 3B | Ref. 4B |
|---|---|---|---|---|---|
| Kneaded | (A1) Vinyl group-containing linear | | | | |
| product | organopolysiloxane | | | | |
| component | (A1-1) Low vinyl rubber | 80 | 80 | 80 | 80 |
| [parts by | (A1-2) High vinyl rubber | 20 | 20 | 20 | 20 |
| weight] | (C) Silica particles | 50 | 50 | 50 | 55 |
| | (D) Silane coupling agent | | | | |
| | (D1) Hexamethyl disilazane | 10 | 10 | 10 | 10 |
| | (D2) Divinyl tetramethyl disilazane | 0.5 | 0.5 | 0.5 | 0.5 |
| | (F) Water | 5.25 | 5.25 | 5.25 | 5.25 |
| | (A2) Vinyl group-containing | 1.04 | 1.04 | 1.04 | 1.04 |
| | branch organopolysiloxane | | | | |
| Additive | (B) Organohydrogen polysiloxane | | | | |
| component | (B1) Linear organohydrogen | 0.39 | 0.31 | 0.47 | 0.38 |
| [parts by | polysiloxane | | | | |
| weight] | (B2) Branch organohydrogen | 0 | 0 | 0 | 0 |
| | polysiloxane | | | | |
| | (E) Platinum catalyst | 0.05 | 0.05 | 0.05 | 0.05 |
| Evaluation | Tensile strength [MPa] | 8.3 | 6.5 | 9.5 | 6.3 |
| | Stretch at break [%] | 1672.8 | 2082 | 1433.2 | 1922.8 |
| | Tearing strength [N/mm²] | 51.7 | 43.3 | 49.6 | 45 |
| | Stroke at break [mm] | 280.8 | 402.7 | 175.8 | 406.8 |
| | 50% strain modulus [MPa] | 0.91 | 0.67 | 1.16 | 0.81 |
| | Hardness | 48.3 | 42.5 | 52.8 | 47.1 |
| | Total light transmittance (1 mm thickness) | 89.2 | 88.5 | 89.9 | 89.6 |
| | Haze value | 11.4 | 15.3 | 11 | 13.6 |

As is obvious from comparison of Examples 1A to 3A with Reference Example 1A, comparison of Examples 4A to 6A with Reference Example 2A, as well as comparison of Examples 10A and 11A with Reference Example 3A in Table 1, in the case where the vinyl group-containing organopolysiloxane (A) contained both the vinyl group-containing linear organopolysiloxane (A1) and the vinyl group-containing branch organopolysiloxane (A2), obtained were silicone rubbers each having more excellent tensile strength and tearing strength.

This is estimated to be because the crosslink density of the silicone rubber becomes higher by using the vinyl group-containing branch organopolysiloxane (A2) as the vinyl group-containing organopolysiloxane (A)

As is obvious from comparison of Examples 1B to 6B with Reference Example 1B to 4B, in the case where the organohydrogen polysiloxane (B) contained the branch organohydrogen polysiloxane (B2) or the mixture (B3) of the linear organohydrogen polysiloxane (B1) and the branch organohydrogen polysiloxane (B2), obtained were silicone rubbers each having more excellent tensile strength and tearing strength.

This is estimated to be because the crosslink density of the silicone rubber becomes higher by using the branch organohydrogen polysiloxane (B2) as the organohydrogen polysiloxane (B).

### INDUSTRIAL APPLICABILITY

According to the present invention, a silicone rubber-based curable composition contains a vinyl group-containing organopolysiloxane (A), an organohydrogen polysiloxane (B), silica particles (C), a silane coupling agent (D), and a platinum or platinum compound (E). The vinyl group-containing organopolysiloxane (A) or both the vinyl group-containing organopolysiloxane (A) and the organohydrogen polysiloxane (B) contains predetermined compounds. This makes it possible to provide a silicon rubber-based curable composition which can produce a silicone rubber having excellent tensile strength and tearing strength, a method of producing a silicone rubber by using the silicon rubber-based curable composition, a silicone rubber produced by using the silicon rubber-based curable composition, a molded body obtained by using the silicon rubber-based curable composition, and a medical tube obtained by bringing the molded body into a tubular shape. Therefore, the present invention has industrial applicability.

What is claimed is:

1. A silicone rubber-based curable composition, comprising:
a vinyl group-containing organopolysiloxane (A);
an organohydrogen polysiloxane (B);
silica particles (C);
a silane coupling agent (D); and
a platinum or platinum compound (E),
wherein satisfied is the following requirement X, or both the following requirements X and Y:
Requirement X: the vinyl group-containing organopolysiloxane (A) contains both a vinyl group-containing linear organopolysiloxane (A1) and a vinyl group-containing branch organopolysiloxane (A2),
Requirement Y: the organohydrogen polysiloxane (B) contains a mixture (B3) of a linear organohydrogen polysiloxane (B1) and a branch organohydrogen polysiloxane (B2), or the branch organohydrogen polysiloxane (B2).

2. The silicone rubber-based curable composition as claimed in claim 1, wherein the vinyl group-containing linear organopolysiloxane (A1) is represented by the following formula (1): 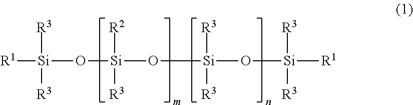
where in the formula (1), “m” is an integer number of 1 to 1,000, “n” is an integer number of 3,000 to 10,000, R¹ is a substituted or unsubstituted alkyl, alkenyl or aryl group having a carbon number of 1 to 10 or a hydrocarbon group combining them, R² is a substituted or unsubstituted alkyl, alkenyl or aryl group having a carbon number of 1 to 10 or a hydrocarbon group combining them, and R³ is a substituted or unsubstituted alkyl or aryl group having a carbon number of 1 to 8 or a hydrocarbon group combining them, but at least one of R¹ and R² is the hydrocarbon group containing the substituted or unsubstituted alkenyl group having the carbon number of 1 to 10.

3. The silicone rubber-based curable composition as claimed in claim 1, wherein the vinyl group-containing branch organopolysiloxane (A2) is represented by the following formula (4): 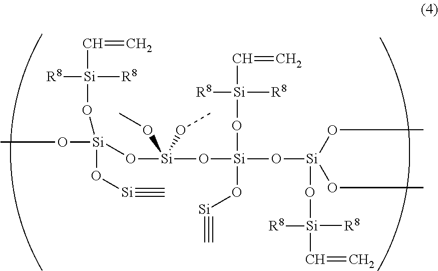
where in the formula (4), R⁸ is a substituted or unsubstituted alkyl or aryl group having a carbon number of 1 to 8 or a hydrocarbon group combining them, “—O—Si≡” represents that Si has a branch structure spreading in three dimension.

4. The silicone rubber-based curable composition as claimed in claim 1, wherein the linear organohydrogen polysiloxane (B1) is represented by the following formula (2) 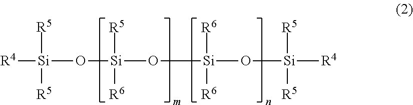
where in the formula (2), “m” is an integer number of 0 to 300, “n” is an integer number of “300-m”, R⁴ is a substituted or unsubstituted alkyl, alkenyl or aryl group having a carbon number of 1 to 10, a hydrocarbon group combining them or a hydrido group, R⁵ is a substituted or unsubstituted alkyl, alkenyl or aryl group having a carbon number of 1 to 10, a hydrocarbon group combining them or a hydrido group, and R⁶ is a substituted or unsubstituted alkyl or aryl group having a carbon number of 1 to 8 or a hydrocarbon group combining them, but at least two of R⁴s and R⁵s are the hydrido groups.

5. The silicone rubber-based curable composition as claimed in claim 1, wherein the branch organohydrogen polysiloxane (B2) is represented by the following average composition formula (C):
(Hₐ(R⁷)₃₋ₐSiO_{1/2})ₘ(SiO_{4/2})ₙ (C)
where in the formula (C), R⁷ is an univalent organic group, “a” is an integer number of 1 to 3, “m” is the number of “Hₐ(R⁷)₃₋ₐSiO_{1/2}” unit, and “n” is the number of “SiO_{4/2}” unit.

6. The silicone rubber-based curable composition as claimed in claim 1, wherein the mixture (B3) contains the linear organohydrogen polysiloxane (B1) and the branch organohydrogen polysiloxane (B2) in a weight ratio of 10:1 to 1:1.

7. The silicone rubber-based curable composition as claimed in claim 1, wherein the silane coupling agent (D) has a hydrolysable group that reacts with a hydroxyl group of the silica particles (C) through dehydration and condensation reaction after being hydrolyzed.

8. The silicone rubber-based curable composition as claimed in claim 7, wherein the silane coupling agent (D) has a hydrophobic group.

9. The silicone rubber-based curable composition as claimed in claim 7, wherein the silane coupling agent (D) has a vinyl group.

10. The silicone rubber-based curable composition as claimed in claim 1, further comprising a water (F).

11. A method of producing a silicone rubber by curing the silicone rubber-based curable composition defined by claim 1 and satisfying both the following requirements X and Y, comprising:
obtaining a kneaded product by kneading at least the vinyl group-containing linear organopolysiloxane (A1), the silica particles (C) and the silane coupling agent (D) with each other; and
obtaining the silicone rubber-based curable composition by kneading at least the mixture (B3) or branch organohydrogen polysiloxane (B2) and the platinum or platinum compound (E) with the kneaded product,
wherein the vinyl group-containing branch organopolysiloxane (A2) is kneaded with the vinyl group-containing linear organopolysiloxane (A1), the silica particles (C) and the silane coupling agent (D) in the kneaded product obtaining step, or is kneaded with the kneaded product together with the mixture (B3) or branch organohydrogen polysiloxane (B2) and the platinum or platinum compound (E) in the silicone rubber-based curable composition obtaining step.

12. The method of producing a silicone rubber as claimed in claim 11, wherein the kneaded product is obtained by kneading, in advance, the vinyl group-containing linear organopolysiloxane (A1) and the silane coupling agent (D) with each other, and then kneading the silica particles (C) therewith.

13. The method of producing a silicone rubber as claimed in claim 12, wherein the silicone rubber-based curable composition is obtained by kneading the vinyl group-containing branch organopolysiloxane (A2) and the mixture (B3) or branch organohydrogen polysiloxane (B2) with a part of the kneaded product, and kneading the platinum or platinum compound (E) with the other part of the kneaded product, and then kneading the kneaded products with each other.

14. A silicone rubber produced by curing the silicone rubber-based curable composition defined by claim 1.

15. A molded body obtained by using the silicone rubber defined by claim 14.

16. A medical tube obtained by bringing the molded body defined by claim 15 into a tubular shape.
